(19) United States
(12) Patent Application Publication
(10) Pub. No.: US 2024/0351756 A1
(43) Pub. Date: Oct. 24, 2024

(54) Child Resistant Container

(71) Applicant: Bradley Zusman, Gresham, OR (US)

(72) Inventor: Bradley Zusman, Gresham, OR (US)

(21) Appl. No.: 18/642,692

(22) Filed: Apr. 22, 2024

Related U.S. Application Data
(60) Provisional application No. 63/461,154, filed on Apr. 21, 2023.

(51) Int. Cl. B65D 50/04; A61J 1/03; A61J 1/14

(52) U.S. Cl. CPC B65D 50/041; A61J 1/03; A61J 1/1418

(57) ABSTRACT

A child resistant container is provided which has a base with an internal cavity for holding ingestible material. An exterior lid is in a rotating engagement with a secondary lid which seals the internal cavity when in an engaged position. The secondary lid is only removable by twisting the exterior lid while concurrently depressing two deflecting portions to cause an engagement of the exterior lid with the secondary lid so it may be rotated.

### BACKGROUND OF THE INVENTION

### 1. Field of the Invention

The invention herein disclosed relates generally to containers. More particularly, it relates to containers with child resistant lids for maintaining medicinal, ingestible products and medications out of the reach of children.

### 2. Prior Art

### BACKGROUND OF THE INVENTION

In the field of medication and ingestible product containers, child-resistant packaging or containers are employed to reduce the risk of children ingesting medications, supplements, and other hazardous materials.

Such containers, having resistance to child access to the contents therein, are often configured with a base having a cavity therein to hold ingestible products. A cap which is removably engageable to the base, provides an impediment to children from opening the cap and gaining access to the contents of the cavity therein.

Although child-resistant lids for containers are not perfect, conventionally there appears to be strong evidence that use of child-resistant lids can significantly reduce child poisoning. The design of such containers, while being configured to be resistant to removal of the lid by a child, should strive to allow reasonably easy removal by an adult.

With respect to the above, before explaining at least one preferred embodiment of the container for ingestible materials with a child resistant lid herein, it is to be understood that the disclosed container system herein is not limited in its application to the details of employment and to any arrangement of steps set forth in the following description or illustrated in the drawings. The various apparatus components, configurations, and methods of employment thereof as herein disclosed, are capable of other embodiments, and of being practiced and carried out in various ways, all of which will be obvious to those skilled in the art once the information herein is reviewed.

Also, it is to be understood that the phraseology and terminology employed herein are for the purpose of description for an understanding of the container device and system herein and should not be regarded as limiting. As such, those skilled in the art will appreciate that the conception upon which this disclosure is based may readily be utilized as a basis for other containers with child resistant caps or lids. It is important, therefore, that the embodiments, objects and claims herein, be regarded as including such equivalent construction and methodology insofar as they do not depart from the spirit and scope of the present invention.

### SUMMARY OF THE INVENTION

The container device herein is configured to provide safe access to ingestible medications, supplements and the like to adult users of such, while concurrently providing a significant impediment to any access by a child. The device features a base having an internal cavity formed therein which communicates with an opening. The internal cavity is sized for holding ingestible medications and supplements and the like, to which children should not have access.

Surrounding the opening which provides access to the internal cavity holding the medication, is a threaded sidewall. This threaded sidewall is configured to have a secondary lid in a threaded engagement therewith. This threaded engagement is provided by complimentary threads formed on a side wall surface of the secondary lid which will engage with the threaded sidewall extending from the base.

The secondary lid is in a rotating free-wheeling engagement with an external lid. The external lid rotates in this engagement with the secondary lid positioned within a recessed area of the external lid. In order to engage or disengage the secondary lid from a threaded engagement with the base of the container, the user must have the ability to discern how such a task is accomplished as well as the physical size and strength to accomplish the engagement task.

In operation, in one mode of rotating engagement, the secondary lid has a central aperture which is rotationally engaged to a mounting projection extending from a lower surface of the external lid. This lower surface of the external lid is hidden and not accessible when the secondary lid is placed in the threaded engagement with the base of the container.

The external lid is configured with a sidewall which surrounds the recessed area thereof and a side surface of the rotationally engaged secondary lid when engaged therewith. As noted, the external lid will rotate freely in its engagement with the secondary lid when the secondary lid is in the mounted position in a threaded engagement to the base of the container. Thus, until removed by compressed engagement of the external lid during a twisting thereof, the secondary lid will remain in a closed position covering the opening to the internal cavity of the base and preventing access to the ingestible material held therein.

A child encountering the container with the secondary lid engaged to the base and sealing the internal cavity will be unable to access the contents of the container. Instead, the internal cavity of the container will encounter the external lid which will spin freely when rotated which will prevent any rotation of the secondary lid in a direction to remove it from the base.

As noted, the external lid, operatively engaged to rotate on the secondary lid, has a top surface and an extending sidewall which completely surrounds a cavity in which the secondary lid is positioned. When the external lid is rotated without knowing how to engage the external lid with the secondary lid, the external lid will simply rotate.

To remove the secondary lid from the sealed engagement over the internal cavity of the base requires an adult sized hand. Such a removal also requires sufficient hand and finger strength to deflect a first deflecting section and a second deflecting section of the sidewall of the external lid which surrounds the secondary lid.

As a first defense to opening the container by a child, the engagement between the external lid and secondary lid to allow removal of the secondary lid is essentially hidden. A second defense to opening by a child may be provided by employing a polymeric or other material for the external lid having a resistance force to deflection toward the secondary lid which exceeds the force that a child can communicate to both the first and second deflecting section.

On a respective interior surface of the sidewall of the external lid, in the area of the first deflecting portion and the second deflecting portion, is located a projection. Each of these projections is configured to engage within a recess formed in the external circumferential surface of the secondary lid. In operation, to open the container to allow removal of the ingestible material held in the internal cavity, a user must grip the external lid in a manner where they can impart sufficient force to at least the first deflecting portion of the sidewall and where present to the second deflecting portion of the sidewall to engage the respective projections thereon into a recess formed in the exterior surface of the secondary lid. With the projections so engaged and with the user exerting continuous inward force to both of the deflecting portions, the user must concurrently twist the external lid. This twisting or rotation will allow the user to rotate the projection-engaged secondary lid along with the external lid and thereby remove both to allow access to the internal cavity of the base and the contents therein.

Re-engagement of the secondary lid to the threaded engagement, with the base to thereby cover the internal cavity and its contents, is accomplished in reverse. The user must, concurrently, depress at least one and preferably both the first and second deflecting portions of the sidewall of the external lid to cause the engagement of projections thereon with the mating recesses formed in the external surface of the secondary lid. While concurrently and continuously bending both of the deflecting portions inward, the user then must rotate the exterior lid which will rotate the secondary lid and allow it to be engaged to the threaded base.

Children lacking the ability to discern the function of the container herein will be prevented in a first manner from access. Even where the child might discern how the external lid functions to rotate the secondary lid, the required dexterity and physical strength to grip the external lid and concurrently bend the deflecting portions thereof, while concurrently rotating the external lid would not conventionally be present in children. This is because children have small hands which are unable to grip both sides of the external lid. Further, children have limited hand strength to deflect the required portions of the external lid. Finally, children also lack the ability to maintain a compressive engagement of opposing sections of the external lid while concurrently twisting it. As such, the container device herein provides a significant deterrent to access by children to ingestible material stored within.

With respect to the above summary description, before explaining at least one preferred embodiment of the container having a child resistant lid or cap herein, it is to be understood that the invention is not limited in its application to the details of operation nor the arrangement of the components or the steps set forth in the following description or illustrations in the drawings. The various methods of implementation and operation of the container device herein, are capable of other embodiments and of being practiced and carried out in various ways which will be obvious to those skilled in the art upon their review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other child resistant containers. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used herein, if not otherwise defined, the term “substantially” means plus or minus five percent. It is an object of this invention to provide a container with a child resistant lid to allow for storage in the container of ingestible medications and the like by adults while preventing access thereto by children.

These together with other objects and advantages, which become subsequently apparent reside in the details of the construction and operation of the container with child resistant lid herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification wherein detailed description is for the purpose of fully disclosing the invention without placing any limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed vehicle container with a child resistant lid herein. It is intended that the embodiments and figures disclosed herein are to be considered illustrative of the invention herein, rather than limiting in any fashion.

### In the Drawings:

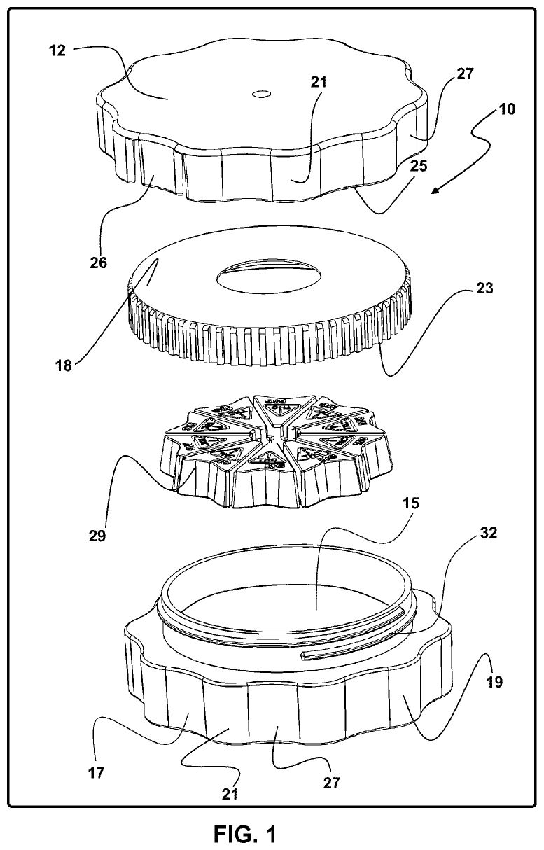

FIG. 1 shows an exploded view of one preferred mode of the child resistant container herein.

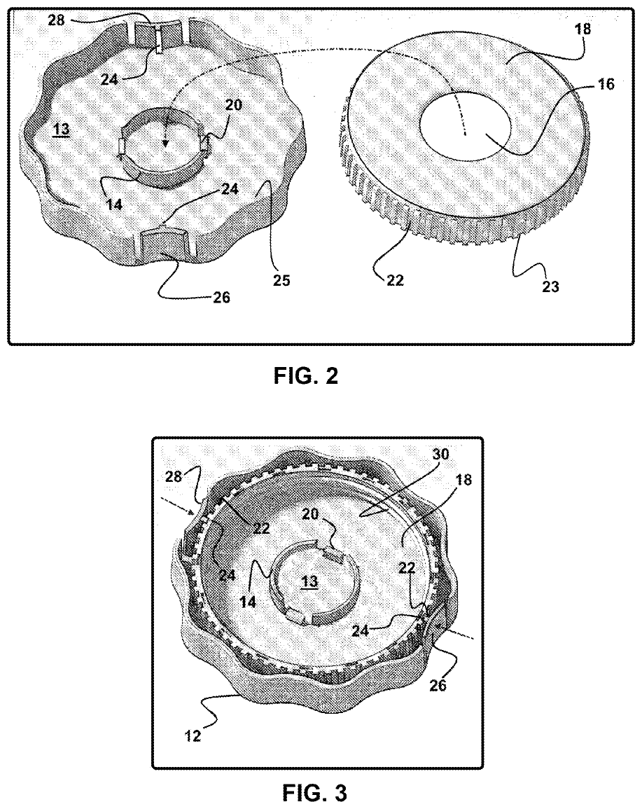

FIG. 2 shows the components for the lid assembly herein in a separated view thereof.

FIG. 3 depicts a lower side view of the container lid assembly showing the assembly formed of the components of FIG. 2.

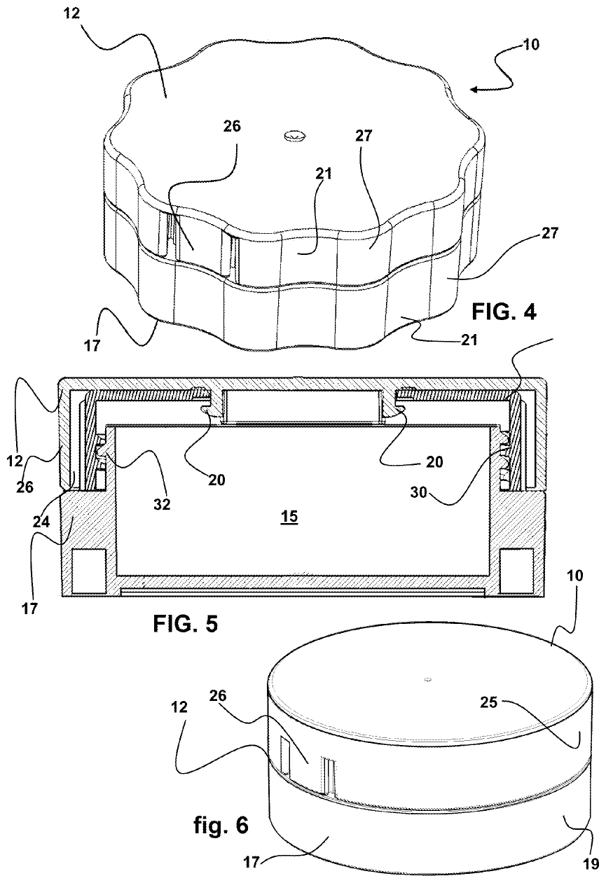

FIG. 4 shows the child resistant container formed of the components of FIGS. 1-3 in a closed configuration.

FIG. 5 is a sectional view through FIG. 4 or 6 which operate in the same fashion.

FIG. 6 depicts a configuration of the child resistant container herein, wherein the exterior lid and container are both round with smooth exterior surfaces.

### DETAILED DESCRIPTION OF THE PREFERRED

### Embodiments of the Invention

In this description, the directional prepositions of up, upwardly, down, downwardly, front, back, top, upper, bottom, lower, left, right, first, second, and other such terms refer to the container device as it is oriented and appears in the drawings and all such terms are used for convenience only and such are not intended to be limiting or to imply that the container device and system has to be used or positioned in any particular orientation.

Now referring to drawings in FIGS. 1-6, wherein similar components are identified by like reference numerals, there is seen in FIG. 1 an exploded view of the components of the device 10 herein. As shown, an exterior lid 12 has a lower surface 13 configured to rotationally engage with the secondary lid 18 in a rotational engagement. While numerous rotational engagements can be positioned thereon and such is anticipated, currently, a mounting projection 14 (FIG. 2) extends from the lower surface 13.

To form a rotational engagement, the mounting projection 14 is configured to project through the opening 16 and to form a freely rotational engagement with the secondary lid 18. By rotational engagement herein is meant any rotating engagement between the external lid 12 and the secondary lid 18 which positions the secondary lid 18 in a recess surrounded by the recessed area bounded by the bottom surface 13 and a sidewall 25 of the exterior lid 12.

FIG. 1 and FIG. 4 show an exterior surface of the base 17 which and the exterior surface of the exterior lid 12 which is curvilineal. The shape is easier for many adults to handle during operation in that it positions a series of shoulders 21 having recesses 27 therebetween. It is easier to grip within the recesses 27 than the rounded configuration of FIG. 6.

As shown in FIG. 2, one mode of rotational engagement is provided by a mounting projection 14 which is curved and has at least one and preferably two deflecting area 20 of the mounting projection 14. During assembly, when the opening 16 is forced toward the mounting projection 14, the deflecting portions 20 will momentarily contract and allow the opening to seat on the mounting projection 14. The deflecting portions 20 of the mounting projection 14 will then return to a biased position which locates them past the edge of the opening 16 and will hold the secondary lid 18 in the rotating engagement to the exterior lid 12. An internal cavity 15 of the base 17 of the container is sized to hold the ingestible material 29 and keep it away from children.

Also shown in FIGS. 1-3 are the secondary lid 18 which has a plurality of recesses 22 formed into the circumferential exterior surface 23 of the side of the secondary lid 18. These recesses 22 are positioned around the circumferential exterior surface 23 in positions to engage with release projections 24 located on an interior surface of each of a first deflecting portion 26 and second deflecting portion 28 of the sidewall of the exterior lid 12. In operation, as noted, the user will compress the first deflecting portion 28 and second deflecting portion 30 inward toward the mounting projection 14 wherein the release projections 24 will engage with the recesses 22 in the secondary lid 18 so long as the deflecting portions are so deflected.

Concurrently, with maintaining the continuous compression to maintain the engagement of the release projections 24 within the recesses 22 in the secondary lid 18, the user must twist the exterior lid 12. The exterior lid 12 must be rotated in a direction which will twist the secondary lid 18 to disengage the lid threads 30 from the container threads 32. Without such continuous compression, concurrent with a twisting of the exterior lid 12, the secondary lid 18 cannot be removed. This concurrent action requirement of compression and rotation is a significant obstacle for most children.

As noted, shown in FIG. 4 is the closed container device 10 herein where the exterior lid 12 is operatively engaged with the secondary lid which is engaged with the base 17. In this closed configuration, the exterior lid 12 will only spin on the rotational engagement with the secondary lid 18. The user must have the strength and hand size to compress the first deflecting portion 26 and the second projecting portion 28 to engage the release projections 24 with the recesses 22. They then must concurrently twist the exterior lid 12 by twisting the exterior lid 12 to open the container.

Shown in FIG. 5 is a sectional view through FIG. 4 or 6 depicting the positioning and engagements of the device for operation. As shown, the exterior lid 12 will freely rotate upon the secondary lid 18 which has a threaded engagement of the lid threads 30 with the container threads 32. Compression of the deflecting portions 26 and 28 will engage the release projections 24 with a recess 22 in the secondary lid 18. Once so engaged and while concurrently exerting continuous pressure to maintain that engagement, the user must twist the exterior lid 12 to remove the secondary lid 18.

Shown in FIG. 6 is a round configuration of the child resistant container. The round configuration has a smooth sidewall 25 on the exterior lid 12 and a smooth rounded exterior surface 19 on the base 17. The rounded curved smooth sidewalls 25 make it harder to hold the base 17 while rotating the exterior lid 12 while concurrently imparting continuous compression to the deflecting portions 26 of the sidewall 25. This rounded mode of the device is thus harder to open for children since there is a sliding smooth surface impeding a good grip to a small hand.

While all of the fundamental characteristics and features of the container having a child resistant lid or cap are disclosed herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

It should also be understood that various equivalent substitutions, modifications, and variations may be made by those skilled in the art, without departing from the spirit or scope of the invention. Consequently, all such modifications and variations and substitutions are included within the scope of the invention as defined by the following claims.

What is claimed is:

1. A child resistant container apparatus comprising:
a base having an internal cavity for holding ingestible material;
said base having container threads on an exterior surface thereof;
an exterior lid having an exterior sidewall surrounding a lower surface thereof;
a secondary lid having lid threads on an interior of a lid sidewall of said secondary lid;
said secondary lid positionable to an engaged position upon said base covering said internal cavity by engagement of said container threads with said lid threads;
said exterior lid in a rotating engagement with said secondary lid having said exterior sidewall completely surrounding said lid sidewall;
said exterior sidewall of said exterior lid having deflecting portions thereof, said deflecting portions having release projections extending therefrom;
said release projections positionable to a removable engagement with recesses formed into an exterior surface of said lid sidewall by a bending of said deflecting portions toward said recesses; and
said secondary lid only being removable from said engaged position by compression of said deflecting portions during a concurrent twisting of said exterior lid to thereby disengage said container threads with said lid threads.

2. The child resistant container apparatus of claim 1 additionally comprising:
said rotational engagement of said exterior lid with said secondary lid being a rotational engagement of an opening formed through a central portion of said secondary lid with a projection extending from said lower surface of said exterior lid.

3. The child resistant container apparatus of claim 1 additionally comprising:
said exterior sidewall of said exterior lid having a curvilineal shape having a plurality of shoulders positioned in between recesses.

4. The child resistant container apparatus of claim 2 additionally comprising:
said exterior sidewall of said exterior lid having a curvilineal shape having a plurality of shoulders positioned in between recesses.

5. The child resistant container apparatus of claim 3 additionally comprising:
an exterior circumference of said base also having a said curvilineal shape having a plurality of secondary shoulders positioned in between secondary recesses.

6. The child resistant container apparatus of claim 4 additionally comprising:
an exterior circumference of said base also having a said curvilineal shape having a plurality of secondary shoulders positioned in between secondary recesses.

7. The child resistant container apparatus of claim 1 additionally comprising:
said exterior sidewall of said exterior lid having a rounded shape having a smooth surface.

8. The child resistant container apparatus of claim 2 additionally comprising:
said exterior sidewall of said exterior lid having a rounded shape having a smooth surface.

9. The child resistant container apparatus of claim 7 additionally comprising:
an exterior circumference of said base also having a said rounded shape having a said smooth surface.

10. The child resistant container apparatus of claim 8 additionally comprising:
an exterior circumference of said base also having a said rounded shape having a said smooth surface.
